(19) United States
(12) Patent Application Publication
(10) Pub. No.: US 2005/0186992 A1
(43) Pub. Date: Aug. 25, 2005

(54) METHOD AND APPARATUS TO ALLOW TWO WAY RADIO USERS TO ACCESS VOICE ENABLED APPLICATIONS

(76) Inventors: Slawomir Skret, Boulder, CO (US); Michael Sajor, .., NJ (US); Dale Hartzell, Boulder, CO (US); Charles Corfield, Boulder, CO (US); Brian Marquette, Boulder, CO (US)

Correspondence Address: HOLLAND & HART, LLP, 555 17TH STREET, SUITE 3200, DENVER, CO, 80201, US

(21) Appl. No.: 10/906,393

(22) Filed: Feb. 17, 2005

Related U.S. Application Data
(60) Provisional application No. 60/546,497, filed on Feb. 20, 2004.

(51) Int. Cl. H04M 1/00

(52) U.S. Cl. 455/563; 455/550.1

(57) ABSTRACT

A radio interface or radio gateway is provided. The radio interface or gateway provides two way radio users the ability to access voice-enabled processor based applications.

### RELATED APPLICATIONS

This application claims priority to U.S. Provisional Patent Application Ser. No. 60/546,497, filed Feb. 20, 2004, titled ASYNCHRONOUS CHANNEL MULTIPLEXING USING A RADIO GATEWAY, incorporated herein by reference as if set out in full.

### FIELD OF THE INVENTION

The present invention relates to two way radio communication and, more particularly, to methods and apparatuses to allow two way radio users to access voice-enabled processor based applications.

### BACKGROUND OF THE INVENTION

Voice or speech-enabled processor based applications are common today. Voice-enabled processor based applications are typically accessed over a telephone connection using conventional telephony protocols including wireless protocols. Voice-enabled processor based applications can also be accessed over cable, optical, or VoIP connections. Telephone users (wireline and wireless), for example, benefit from computer automation via interactive voice response (“IVR”) systems that recognize touch-tone or voice input.

Some computer users have access to dictation systems with speech recognition (such as, for example, Dragon Speech®); however, the recognition engines are tied to the sound card and microphone associated with the computer. Moreover, dictation systems are relatively limited to the creation of documents. Dictation systems do not have the ability to perform more complex functions, such as, automate tasks that are relevant to radio users.

Some amateur and professional radio operators have connected their radios to computers for purposes of transmission/reception of audio (and other data), or for programming their radios. However, they have not used speech recognition to enable applications and services to be delivered via the radio channel.

The telematics industry has introduced in-vehicle systems with embedded speech recognition to allow drives voice control over some functions of their vehicle (such as, for example, controlling sound volume on audio devices, telephone dialing, or the like).

Two way radio users, however, have not had access to voice-enabled processor based applications. Traditionally, radios are not connected to voice-enabled processor based applications because, among other reasons, speech recognition engines are typically tied to telephony interface boards that are not integrated into two way radio equipment. Moreover, phone applications depend on the session controls and switching infrastructure of the telecom network, which are not present in two way radios systems. Furthermore, voice-enabled processor based applications are more closely associated with single user access whereas radios are designed for peer-to-peer or peer-to-group communication. Also, many voice-enabled processor based applications require keypads to generate touch-tones to access, for example, IVR applications.

Thus, it would be desirous to provide a gateway that would allow two way radio users access to voice-enabled processor based applications.

### SUMMARY OF THE INVENTION

To attain the advantages of and in accordance with the purpose of the present invention a system to allow two way radio access to voice-enabled processor based applications is providing. The system includes at least one two way radio and at least one processor. The at least one processor has a radio interface and access to at least one voice-enabled processor based application. The radio interface includes a converter to convert audio signals between a radio protocol and a processor protocol and an emulation signal generator, the emulation signal generator sending a signal to the at least one two way radio to simulate the depression of the push-to-talk button such that the at least one radio transmits.

The present invention also provides a radio interface. The radio interface includes a radio device, the radio device to receive incoming data from a radio user and to broadcast outgoing data to the radio user. A converter coverts the incoming data from the radio user to a digital format usable by a processor and to cover the outgoing data from the processor into an audio signal receivable by the radio user. In order to enable the radio device to broadcast, a transmit key simulator is provided. The transmit key simulator generating a simulation signal usable by the radio device to simulate a radio transmit state.

The foregoing and other features, utilities and advantages of the invention will be apparent from the following more particular description of a preferred embodiment of the invention as illustrated in the accompanying drawings.

### BRIEF DESCRIPTION OF THE DRAWINGS

The accompanying drawings, which are incorporated in and constitute a part of this specification, illustrate embodiments of the present invention, and together with the description, serve to explain the principles thereof. Like items in the drawings may be referred to using the same numerical reference.

FIG. 1 is a functional block diagram of a conventional two way radio communication system;

FIG. 2 is timing diagram showing a transmission of voice data over the radio communication system of FIG. 1;

FIG. 3 is a functional block diagram of a two way radio communication system consistent with an embodiment of the present invention;

FIG. 4 is a functional block diagram of an alterative two way radio communication system consistent with an embodiment of the present invention;

FIGS. 5 and 6 show the system of FIG. 3 in more detail;

FIG. 7 is an electrical schematic of a possible connection between a processor and a radio consistent with an embodiment of the present invention; and

FIGS. 8-10 are functional block diagrams of two way radio communication systems consistent with embodiments of the present invention.

### DETAILED DESCRIPTION

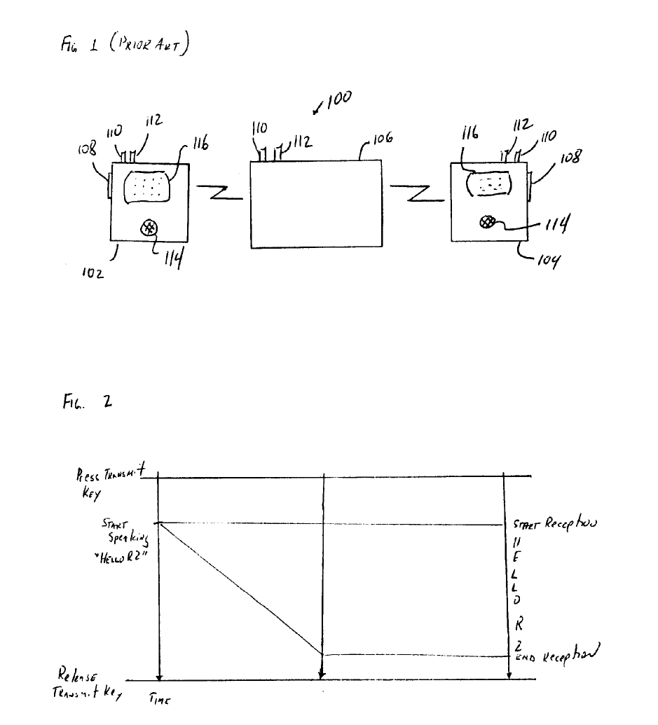

The present invention will be explained with reference to FIGS. 1 to 10. While the present invention is described with reference to conventional two way radios, such as, walkie talkies, for example, one of ordinary skill in the art would recognize on reading the disclosure that the present invention could be used for other peer-to-peer or peer-to-group communication systems. Moreover, while the present invention is described in relation to audio communication, one of ordinary skill in the art on reading the disclosure would understand that the present invention is useful for other media or data transfer systems.

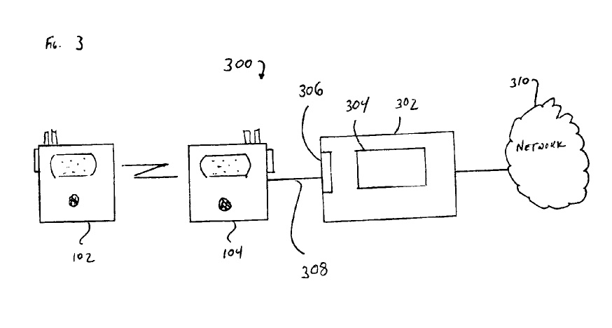

Referring first to FIG. 1, a conventional two way radio communication system 100 is shown. FIG. 2 shows a timing diagram 200 associated with a transmission over system 100. Two way radio communication system 100 comprises a first radio 102 and a second radio 104. First radio 102 and second radio 104 could be in direct communication over a single frequency or a radio repeater 106 between the two. Radio repeater 106 provides the ability to increase the area of radio operation. Generally, when a radio repeater is in the two way radio system, two operating frequencies are employed, a first frequency to broadcast to the repeater and a second frequency to transmit from the repeater. First radio 102 and second radio 104 typically contain a push-to-talk button 108, a volume control 110, and a channel select 112. Radio repeater 106 may include volume or gain control 110 and channel select 112 as well. First radio 102 and second radio 104 also have microphones 114 and speakers 116. Typically, a radio repeater is not a manned unit, so it is designed to operate without the push-to-talk button but rather simply rebroadcasts whatever it receives, often at an increased power level over the mobile radio units.

Referring to FIG. 2, timing diagram 200 starts when the user of first radio 102 presses the push-to-talk button 108. Often, depressing the push-to-talk button 108 cuts the speaker 116 of the associated radio off to inhibit crosstalk and/or echo. As shown in the user of first radio 102 may speak “Hello R2” into microphone 114, which is broadcast to radio repeater 106, which in turn retransmits the “Hello R2.” Second radio 104, turned to the same channel, would receive the transmission “Hello R2” and the speakers 116 would reproduce the sound. While shown in FIG. 2 as being immediately broadcast at second radio 104, one should appreciate some time delay. At such time, the user of second radio 104 could push the corresponding push-to-talk button 108 and reply to the user of first radio 102.

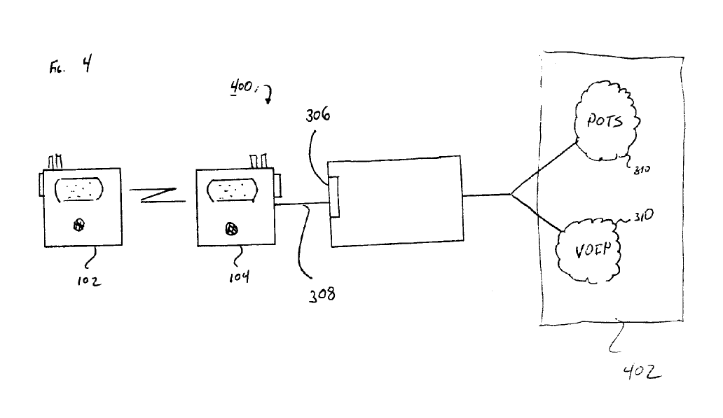

Referring to FIG. 3, a radio system 300 is shown that allows a radio user to access voice-enabled processor based applications. Radio system 300 comprises a first radio 102 and a second radio 104. Radio system 300 could include a radio repeater 106, but radio repeater 106 is optional and is omitted herein for convenience. Attached to second radio 104 is a processor 302. As used herein, the processor should be constructed broadly to include microchips, CPUs, desktop computers, laptop computers, servers, blades, PDAs, electronic games, and the like. Processor 302 hosts one or more voice or speech enabled processor based applications 304 as are conventionally known in the art. Alternatively, processor 302 could provide a connection to a network 310, such as, a LAN, WAN, WLAN, WiFi, Internet, or the like such that network based applications could be accessed. Processor 302 would incorporate a radio interface 306. Second radio 104 and radio interface 306 are connected by communication link 308. Second radio 104 is shown separate from processor 302, but could be integrated into processor 302 as a matter of design choice. Furthermore, radio interface 306 could be integrated into second radio 104 instead of processor 302 as shown. Communication link 308 could be, for example, conventional cable or fiber connection, a ribbon connection, a wireless connection, an internet connection, a bus (if, for example, second radio 104 was integrated into processor 302), or the like. Radio interface 306 obtains audio signals from second radio 104 and converts the audio signal into a format useable by processor 302, such as, for example, digitized audio. Radio interface 306 also obtains output from voice enabled applications 304 from processor 302 and converts the output into a format usable by second radio 104. Finally, radio interface 306 provides an emulation signal, see below, to second radio 104 to simulate depressing the push-to-talk button 108 such that second radio 104 can broadcast the output to first radio 102.

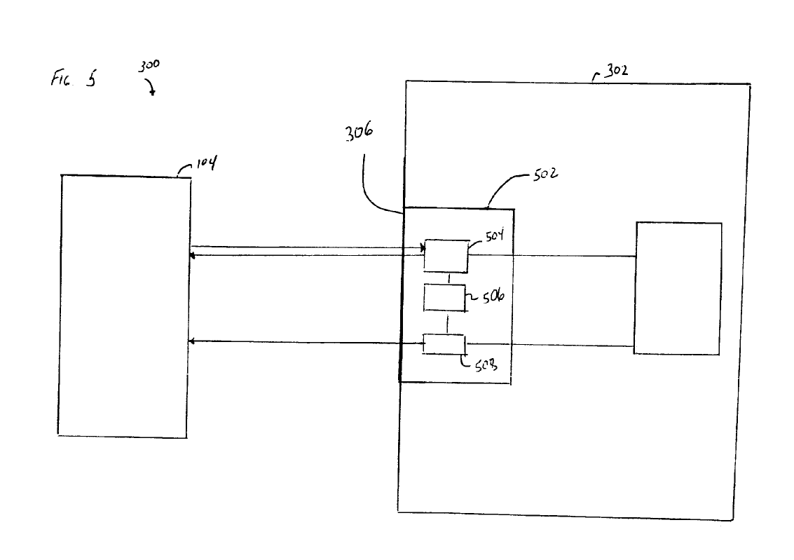

Referring to FIG. 4, an alternative radio system 400 is shown. Radio system 400 is similar to radio system 300 except that radio interface 306 converts the signals to a conventional telephony signal, such as, for example, a PSTN signal or VoIP signal and connects to a voice-enable processor based application over a conventional network 402, such as, the POTS or a VoIP network.

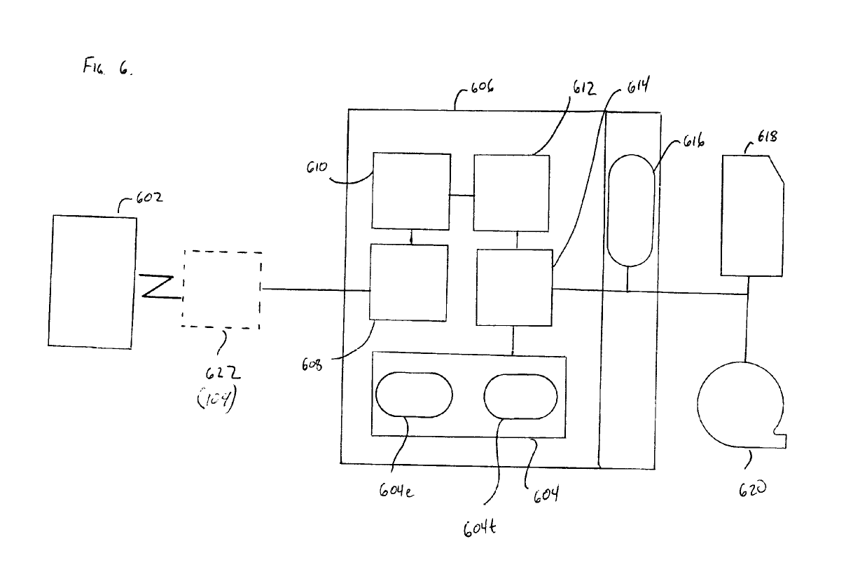

Referring now to FIG. 5, radio system 300 is shown with more detail associated with the radio interface 306. Radio interface as shown includes an electrical circuit 502 having a converter 504 to convert audio output from the second radio 104 and processor 302 into appropriate signals for the corresponding device. In other words, audio from second radio 104 is converted to a format usable by processor 302 and audio output from processor 302 is converted to a format usable by second radio 104. Electrical circuit 502 also has an emulator control 506. Emulator control 506 provides transmit key control of second radio 104. A transmit key signal generator 508, which could be a software module running on processor 302 or a different processor as a matter of choice, would send a transmit-key signal to second radio 104. The transmit key signal would be generated based on a signal from emulator control 506 and could be delivered to second radio 104 using, for example, a USB or other digital interface a processor 302. The transmit key simulation would simulate depressing the push-to-talk button 108 on second radio 104 to allow second radio 104 to transmit output from processor 302.

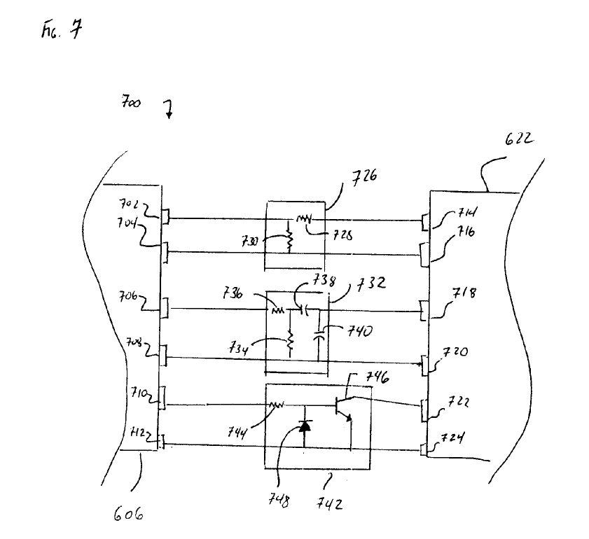

Referring now to FIG. 6, a radio system 600 connecting radio 602 to voice-enabled processor based applications 604 is shown. Voice-enable processor based applications 604 include, among other things, speech recognition engines 604e and text to speech engines 604t. Radio system 600 includes a processor 606 having a radio interface 608, a resource director 610, a call controller 612, and an application engine 614. Application engine 614 is connected to voice-enabled processor based application 604, which are shown hosted by processor 606, but could be hosted on separate processors connected via a serial bus, other digital connector, network or the like. Application engine 614 may be connected to application logic and voice systems 616 and/or other external systems 618 and external data in a remote storage device 620. Other than the connection of radio 602 to processor 606 via the radio interface 608, operation of processor 606 is further described in pending U.S. patent application Ser. No. 09/965,057, titled MEDIA SESSION FRAMEWORK USING A CONTROL MODULE TO DIRECT AND MANAGE APPLICATION AND SERVICE SERVERS, filed Sep. 26, 2001, incorporated herein by reference.

A base station 622 is shown in phantom in FIG. 6. Base station 622 is optional, but could be used to increase the range of radio system 600. Base station 622 could be integrated into processor 606 and/or radio interface 608 as desired. Base station 622 is interchangeable with radio 104.

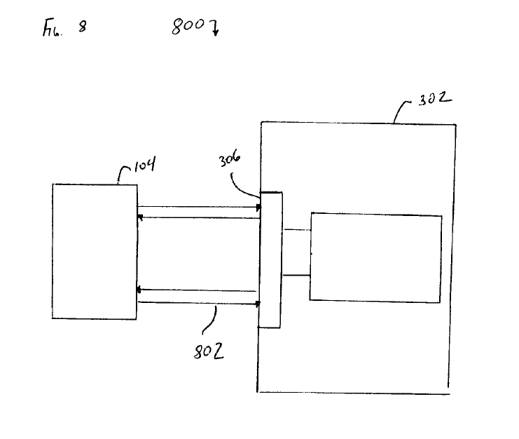

Referring now to FIG. 7, an electrical circuit 700 is shown. Electrical circuit 700 is one possible configuration for a radio interface, such as the radio interface 608. As shown, electrical circuit 700 provides an interface between processor 606 and base station 622. Processor 606 has a number of connections including a microphone input 702, a microphone ground 704, a speaker output 706, a speaker ground 708, an emulation signal output 710, and an emulation signal ground 712. Base station 622 has a number of corresponding connections including an audio output 714, an audio ground 716, an audio input 718, an audio ground 720, an emulation signal input 722, and an emulation signal ground 724. First impedance 726 exists between microphone input 702 and microphone ground 704, and audio output 718 and audio ground 720. First impedance 726 may include a pair of resistors 728 and 730 as shown. Second impedance 732 exists between speaker output 706 and speaker ground 708, and audio input 718 and audio ground 720. Second impedance 732 may include a pair of resistors 734 and 736 as well as other impedance devices such as capacitors 738 and 740. Third impedance 742 exists between emulation signal output 710 and emulation signal ground 712, and emulation signal input 722 and emulation signal ground 724. Third impedance 742 may include resistors 744, a transistor or switch 746, and a diode 748.

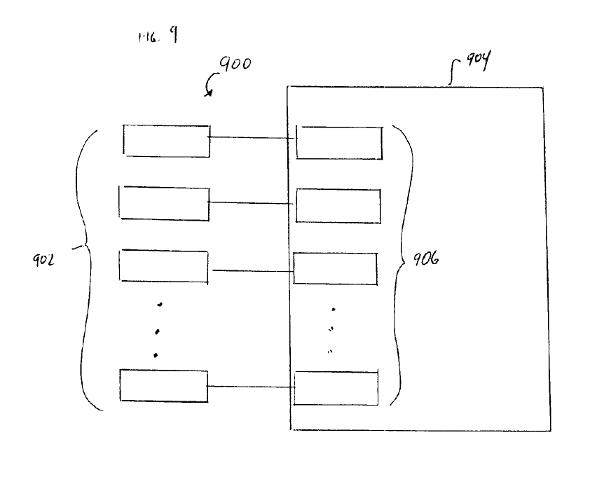

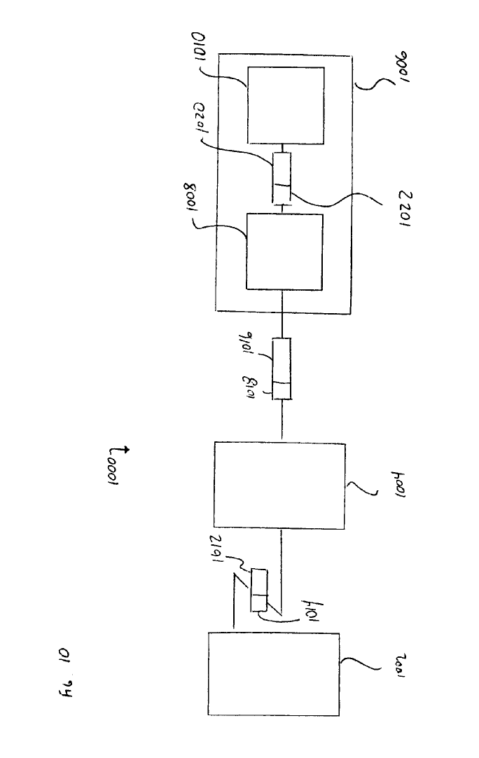

As described above, the system implementation is designed for use with conventional radios, with or without radio repeaters or base stations. Conventional radios do not include signaling or channel multiplexing schemes to increase radio resource utilization, which is available in some custom radios and is becoming more commonplace. However, as will be further explained below with reference to FIGS. 8 and 9, the radio gateway or radio interface may be used in radio systems having multiplexing capabilities. One solution to multiplex radio systems involves using signaling and control schemes through implementation of appropriate channel status indicators in the radio interface. The status indicators advise the software and/or hardware components of when transmission over the channel is possible and permitted, and when the virtual communications channel selected is unavailable for use. This situation is commonly presented in “trunking” or other channel controlled repeater networks. Conventional trunking is known in the art and will only be explained as necessary and related to the present invention.

Referring first to FIG. 8, a trunked radio system 800 is shown. Trunked radio system 800 is similar to the system described in FIG. 5, and the similarities will not be further explained, but includes a channel busy signal 802. Channel busy signal 802 informs processor 302 that transmission of the audio out is not currently possible because the channel second radio 104 would broadcast on is being used for another user, task, or the like.

Trunked radio system 800 accounts for proper operation of the radio system leveraging using conventional functionality, such as, Continuous Tone Coded Squelch System (“CTCSS”) or proprietary systems, such as PRIVATE LINE®, from Motorola. In these systems, multiple user sets share a single frequency or channel of operation by detecting a predetermined, continuously transmitted sub-audible tone. Typically, the tone ranges from 67 to 254 Hz. The squelch of radios belonging to user groups assigned to a given tone does not open if that tone is not received. During periods of squelch closure; therefore, the actual channel may be occupied by a transmission from a member of another tone group, and the channel may not be available for use. In this instance, audio output from processor 302 would be cached or stored until the channel becomes un-squelched.

CTCSS equipped radios, for example, typically offer visual and electrical notification of channel activity during periods of squelch closure, in other words, when the channel is in use by another tone group and unavailable for the particular radio user. The radio interface or radio gateway detects the channel busy notification, using for example a Carrier Detect signal provided by equipment radios, and holds the outgoing data. Once the channel busy signal is removed, the held data is transmitted as described above.

As one of skill in the art would likely recognize, the above systems provides access to voice-enable processor based applications. But, all users of the radio channel have access through only that channel. Further, each user can hear interactions between other users and the voice-enabled processor based applications. Moreover, one user's interaction with the processor can be interrupted by another user's interaction. Finally, it is difficult to provide security and/or privacy over the channels. FIG. 9 shows a multiple radio system 900 addressing these concerns. Multiple radio system 900 includes a plurality of radios 902 and a processor 904. Processor 904 has a plurality of radio interfaces 906 (or a single radio interface with a plurality of access ports/pins). Each radio 902 is connected to a corresponding radio interface 906. Referring back to FIG. 7, for example, each radio 902 to interface 906 would necessarily provide a microphone input 702, a microphone ground 704, a speaker output 706, a speaker ground 708, an emulation signal output 710, and an emulation signal ground 712. Base station 622 has a number of corresponding connections including an audio output 714, an audio ground 716, an audio input 718, an audio ground 720, an emulation signal input 722, and an emulation signal ground 724. Impedance 726 exists between microphone input 702 and microphone ground 704, and audio output 718 and audio ground 720.

Referring now to FIG. 10, an alternative multi user radio system 1000 constructed in accordance with the present invention is shown. Radio system 1000 is shown with a first radio 1002 and a second radio 1004. A radio repeater could be used as well but is omitted for convenience. Second radio 1004 is connected to a processor 1006 via a radio interface 1008 or radio gateway. Processor 1006 is shown as hosting applications 1010, but applications 1010 could be remote from processor 1006.

As shown, first radio 1002 would broadcast an audio signal 1012 to second radio 1004. First radio 1002 would append a radio identification header 1014 to the audio signal 1012. Second radio 1004 would send a retransmitted audio signal 1016 with a retransmitted radio identification header 1018 to radio interface 1008. Radio interface 1008 would convert the audio signal into a usable format 1020 and convert the radio identification header into a session identification header 1022. Session header 1022 would be used by processor 1006 to identify the session for the radio user. As a result, processor 1006 knows which user an application is interacting with and can segregate that user's communication from other users and other applications. The return, or output audio, from the voice-enabled processor based applications would transmit to first radio 1002 with radio identification header 1014 so that only radios designated as authorized for communications associated with radio identification header 1014 could receive the transmission. Thus, using the radio identification creates a session for an individual radio user, associates the radio's identification with a session identification, provides one-to-one mapping for all of the traffic between the radio and the application, and is a pass-through for the audio and any other media content, which the application(s) and/or radio(s) support.

While the invention has been particularly shown and described with reference to an embodiment thereof, it will be understood by those skilled in the art that various other changes in the form and details may be made without departing from the spirit and scope of the invention.

1. A system to allow two way radio access to voice-enabled processor based applications, the system comprising:
at least one two way radio; and
at least one processor, the at least one processor comprising:
a radio interface, and
at least one voice-enabled processor based application, wherein the radio interface comprises:
a converter to convert audio signals between a radio protocol and a processor protocol;
an emulation signal generator, the emulation signal generator sending a signal to the at least one two way radio to simulate a transmission status such that the at least one radio transmits.

2. The system of claim 1, wherein the at least one processor comprises a plurality of processors connected through a network.

3. The system of claim 2, wherein the at least one voice-enabled processor based application is hosted remote from the radio interface and accessible through the network.

4. The system of claim 1, further comprising at least one radio repeater.

5. The system of claim 1, wherein the radio interface further comprises an emulator control, the emulator control controls when the emulation signal generator generates the signal.

6. The system of claim 1, further comprising at least another radio connected to the at least one radio using two way radio protocols.

7. The system of claim 6, wherein the at least another radio provides a radio identification with an audio signal such that the at least one processor can associate the at least one voice-enabled processor based application with the radio identification.

8. The system of claim 6, wherein the at least another radio comprises a plurality of other radios connected to the at least one radio.

9. The system of claim 1, wherein the at least one radio comprises a plurality of first radios and the at least one radio interface comprises at least a corresponding plurality of radio interfaces.

10. The system of claim 9, further comprising a plurality of second radios corresponding to the plurality of first radios such that users of the plurality of second radios can access the at least one voice-enabled processor based application.

11. The system of claim 1, wherein the at least one radio provides a channel busy signal to the radio interface causing the radio interface to delay broadcasting.

12. The system of claim 11, wherein the channel busy signal comprises a squelch signal.

13. The system of claim 12, wherein the squelch signal is a continuous tone coded squelch signal.

14. A radio interface to connect a radio to a processor such that the radio can transmit data to and receive data from voice-enabled processor based applications, the radio interface comprising:
a radio device, the radio device to receive incoming data from a radio user and to broadcast outgoing data to the radio user;
a converter, the converter to covert the incoming data from the radio user to a digital format usable by a processor and to cover the outgoing data from the processor into an audio signal receivable by the radio user; and
a transmit key simulator, the transmit key simulator generating a simulation signal usable by the radio device to simulate a radio transmit state.

15. The radio interface of claim 14, wherein the radio is remote from the converter and the transmit key simulator.

16. The radio interface of claim 14, wherein the radio device is a radio repeater.

17. The radio interface of claim 14, wherein the radio device is a two way radio.

18. The radio interface of claim 14, wherein the radio device provides a channel busy signal when a channel is not available for transmission.

19. The radio interface of claim 14, wherein the radio device receives incoming data from a plurality of radio users and broadcasts outgoing data to the plurality of radio users.
